(19) United States
(12) Patent Application Publication
(10) Pub. No.: US 2023/0161018 A1
(43) Pub. Date: May 25, 2023

(54) Optoelectronic sensor and method for the alignment of an optoelectronic sensor

(71) Applicant: SICK AG, Waldkirch (DE)

(72) Inventors: Christoph MENZEL, Waldkirch (DE); Boris BALDISCHWEILER, Waldkirch (DE)

(21) Appl. No.: 17/990,006

(22) Filed: Nov. 18, 2022

(30) Foreign Application Priority Data
Nov. 19, 2021 (DE) 102021130327.3

(51) Int. Cl. G01S 7/497; G01S 7/481; G01S 7/4861; G01S 7/486

(52) U.S. Cl. CPC G01S 7/497; G01S 7/4811; G01S 7/4861; G01S 7/4868

(57) ABSTRACT

An optoelectronic sensor is provided having at least one measurement light source for transmitting at least one measurement light beam in the infrared wavelength range along a transmission beam path into a monitored zone; a light receiver for receiving measurement light beams remitted or reflected from the monitored zone and for generating corresponding received signals; and having a control and evaluation unit for controlling the light receiver and the measurement light source and for evaluating the received signals, The optoelectronic sensor has at least one nonlinear optical element for generating at least one pilot light beam in the visible wavelength range from at least one portion of the measurement light beam.

The invention relates to an optoelectronic sensor having at least one measurement light source for transmitting at least one measurement light beam in the infrared wavelength range along a transmission beam path into a monitored zone; a light receiver for receiving measurement light beams remitted or reflected from the monitored zone and for generating corresponding received signals; and a control and evaluation unit for controlling the light receiver and the measurement light source and for evaluating the received signals. The invention further relates to a method for the alignment of an optoelectronic sensor.

Many optoelectronic sensors work in accordance with the sensing principle in which a light beam is transmitted into the monitored zone and the light beam reflected by an object is received again in order then to electronically evaluate the received signal, for example for a distance measurement. The time of flight is often measured here using a known phase method or pulse method to determine the distance of a sensed object. Optoelectronic sensors that use this method are frequently called light sensors, TOF (time of flight) sensors, or LIDAR (light detection and ranging) sensors. To expand the measured zone, the light beam can be moved, as is the case in a laser scanner. A light beam generated by a laser there periodically sweeps over the monitored zone with the aid of a deflection unit. In addition to the measured distance information, a conclusion is drawn on the angular location of the object from the angular position of the deflection unit and the site of an object in the monitored zone is thus detected in two-dimensional polar coordinates. The scanning movement is achieved by a rotating mirror in most laser scanners. It is, however, also known to instead have the total measurement head rotate with the light transmitters and light receivers.

Optoelectronic sensor of the initially named kind can work with visible light, but as with light in the infrared wavelength range. The use of infrared light has the advantage that the measurement is not perceived as irritating. In addition, light sources that emit infrared light, for example a vertical cavity surface emitting lasers (VCSELs), are available in smaller sizes than laser diodes that emit visible light. A sensor can therefore be built correspondingly smaller.

An infrared signal, however, has the disadvantage that the detection zone, in particular the specific location of the distance measurement on the respective surface, cannot be recognized by the human eye without additional aids, which in particular makes the assembly and the alignment of the sensor to a monitored zone more difficult.

It is known from the prior art to superpose a visible so-called pilot or target beam on the infrared measurement beam, typically using a dichroitic mirror such as described in US 20040070745 A1. Such systems are, however, comparatively large and the adjustment of the measurement beam and the pilot mean is moreover complex and prone to losses of adjustment. In addition, a further light source is necessary to provide the pilot beam, whereby the number of components and thus the complexity of the sensor is increased.

Starting from this prior art, it is the object of the invention to provide an improved optoelectronic sensor and an improved method for the alignment of an optoelectronic sensor.

This object is satisfied by an optoelectronic sensor and by a method for the alignment of an optoelectronic sensor in accordance with the respective independent claim.

The invention starts from the basic idea of converting at least a portion of a measurement light beam transmitted from a measurement light source of an optoelectronic sensor in the infrared wavelength range (typically between 900 nm and 1600 nm) by means of frequency multiplication into a pilot light beam in the visible wavelength range. This can be done by known methods of frequency doubling (second harmonic generation, SHG) or frequency tripling (third harmonic generation THG), with a doubling or tripling of the frequency of the irradiated measurement light beam taking place in a nonlinear optical element. The wavelength of the infrared measurement light beam irradiated into the nonlinear medium is thus halved or divided by three so that a pilot light beam having a visible wavelength is generated.

An optoelectronic sensor in accordance with the invention thus has at least one measurement light source for transmitting at least one measurement light beam in the infrared wavelength range along a transmission beam path into a monitored zone. A light beam is here not to be understood as a beam in the sense of geometrical optics within a larger bundle of rays, but rather as a light beam that generates corresponding light spots in the monitored zone on an incidence onto an object. An associated light receiver is able to generate received signals from reflected or remitted measurement light beams. A control and evaluation unit controls the measurement light source and the light receiver and can evaluate the received signals of the light receiver to acquire information on the object such as a distance from the sensor.

At least one nonlinear optical element is arranged in the transmission beam path and is configured to generate a pilot light beam in the visible wavelength range from at least one portion of the measurement light beam in the infrared wavelength range by frequency quadrupling. An optical element is to be understood as a nonlinear optical element here in which a frequency quadrupling of the light irradiated into the medium takes place by nonlinear interaction. Known nonlinear optical elements are, for example, birefringent crystals of lithium niobate, potassium hydrogen phosphate, beta barium borate, or lithium triborate. Innovative materials for nonlinear optical elements are, for example, graphene or so-called two-dimensional transition metal dichalcogenides (TMDCs).

Since the pilot light beam generates visible light spots on objects in the monitored zone, the sensor can then be simply aligned in the visible wavelength range in the monitored zone with the aid of the pilot light beam.

The invention has the advantage that a separate light source is not necessary for the generation of a pilot light beam so that the complexity of the sensor is reduced.

The nonlinear optical element can preferably be configured as a so-called optical metamaterial. Optical metamaterials have structure sizes that are smaller than the wavelengths of the light irradiated in. Metamaterials for frequency multiplication are described, for example, in U.S. Pat. No. 7,515,330 B2. The use of a metamaterial as a nonlinear optical element has the advantage that a more efficient frequency multiplication is possible and thus smaller measurement light powers are required. Structured materials that are resonant at the measurement light wavelength or at the pilot light wavelength or at both due to their structural shape are in particular to be understood as metamaterials or metasurfaces. In this respect, the nonlinear material can itself be structured such that the individual elements are resonant or the resonant metamaterial can be surrounded by an unstructured nonlinear material, for example metallic particles on a layer of a nonlinear material. Due to this resonance, there is a field enhancement in the nonlinear material or at its surface and thus an amplified nonlinear frequency conversion, that means a conversion efficiency increased with respect to an unstructured bulk material. Materials that have a nonlinearity of the second order electrical susceptibility (χ2) that can generate a frequency doubling of the irradiated light are particularly advantageous, since the efficiency of the frequency conversion generally decreases by the order n of the nonlinearity.

The nonlinear optical element can particularly preferably be configured as an optical metasurface, also only called a “metasurface” in the following, that has a considerably smaller extent in the beam direction than the above-named birefringent crystals or metamaterials. Such metasurfaces can also be suitable for beam shaping of the measurement light beam and/or the pilot light beam as will be explained in even more detail further below.

The nonlinear optical element can preferably be arranged in the transmission beam path of the optoelectronic sensor such that the measurement light beam and the pilot light beam extend in a collinear, in particular coaxial, manner. The measurement light beam and the pilot light beam are thereby superposed and can generate substantially overlapping light spots in the monitored zone.

In an embodiment of the invention, a transmission optics for setting aperture angles and/or diameters of the measurement light beam and/or of the pilot light beam can be arranged downstream of the nonlinear optical element in the light beam direction. The nonlinear optical element is then arranged accordingly between the measurement light source and the transmission optics. The size of the light spots generated on the incidence on an object in the monitored zone can thus be set. The transmission optics can be designed as a separate optics or as a component of the nonlinear optical element.

Alternatively or additionally, a collimation optics for collimating the measurement light beams can be arranged upstream of the nonlinear optical element in the direction of the light beam. The collimation optics is then arranged accordingly between the measurement light source and the nonlinear optical element. The collimation optics can be designed as a separate optics, can be a component of the measurement light source or a component of the nonlinear optical element. The beam diameter of the measurement light beam can be adapted and an efficient illumination of the nonlinear optical element can take place by the use of a collimation optics.

The transmission optics and/or the collimation optics can preferably be configured as metasurfaces. Metasurfaces in the sense of this application are to be understood as optically effective layers that have structures having structure sizes smaller than the wavelengths of the measurement light beam and that typically have a binary height profile. Such surfaces are known from the technical literature (e.g.: Flat optics with designer metasurfaces, Nature Materials 13, 139-150 (2014). DOI: 10.1038/NMAT3839) and can vary properties of the measurement light beam such as the phase, amplitude, and thus the direction of propagation, the polarization, or the wavelength in a defined manner by a suitable selection of the structures, with the change in particular being able to take place independently of the wavelength. Optics composed of metasurfaces are also called “flat optics” since their extent in the beam direction is much smaller with a comparable optical effect than the classical optics and can typically be in the range from 50 nm to 1500 nm, with metasurfaces of metallic materials typically having smaller extents than metasurfaces of dielectric materials.

The use of metasurfaces has the advantage that properties of the measurement light beam and of the pilot light beam can be varied independently of one another. In addition, due to the small extent of the metasurfaces in the light beam direction, a particularly compact design of the sensor is possible.

The optoelectronic sensor can be configured to move the nonlinear optical element into and out of the transmission beam path. The nonlinear optical element can be arranged as movable for this purpose; for example, it can be pivotable in and out of the transmission beam path by means of a filter wheel or a comparable mechanism. After the alignment of the sensor has taken place, the non-linear optical element can be moved out of the transmission beam path so that the total diameter of the transmission beam path is again available for the measurement light beam.

In an embodiment of the invention, a nonlinear optical element designed as a metasurface can be formed as a film or can comprise a film that can be applied to a window of the optoelectronic sensor through which the measurement light beams are conducted into the monitored zone. When the film has been applied to the window, at least a portion of the measurement light beam in the infrared wavelength range can be converted into a pilot light beam in the visible wavelength range. After the alignment or the adjustment of the sensor has taken place, the film can be removed from the window again so that only the at least one measurement light beam in the infrared wavelength range is transmitted into the monitored zone. The film can preferably be reusable and thus be used multiple times on one or more sensors. An inexpensive design thus results from the alignment of one or more sensors. The film can optionally also comprise metasurfaces for the beam shaping of the measurement light beam and/or the pilot light beam, in particular for the setting of the aperture angles of the measurement light beam and/or the pilot light beam.

In a further embodiment, a window of the optoelectronic sensor through which the measurement light beams are conducted into the monitored zone can comprise the nonlinear optical element designed as a metasurface, with the window being able to be replaced with a window without a nonlinear optical element after the alignment or adjustment of the sensor. An adjustment means can thus be provided that can have improved robustness on a multiple use in comparison with the film described in the previous embodiment. The window can, like the film, optionally also comprise metasurfaces for the beam shaping of the measurement light beam and/or the pilot light beam, in particular for the setting of the aperture angles of the measurement light beam and/or the pilot light beam.

In the different embodiments, an optical beam shaping element for varying a beam cross-section of the pilot light beam can be arranged downstream of the nonlinear optical element in the beam direction. The optical beam shaping element can be configured, for example, such that the pilot light beam generates cruciform light spots on an incidence on an object in the monitored zone. The alignment of the sensor can be further simplified by a corresponding light spot shape. The optical beam shaping element can be configured as a diffractive optical element or as a metasurface. The beam shaping element can alternatively be configured such that the pilot light beam and the measurement light beam generate concentric light spots on an incidence on an object in the monitored zone, with a diameter of a light spot generated by the pilot light beam being smaller than a diameter of a light spot generated by the measurement light beam, or vice versa.

A reception optics for focusing the reflected or remitted measurement light beams onto the light receiver can be arranged upstream of the light receiver. The reception optics can be designed as a metasurface in a comparable manner to the transmission optics. The metasurface can be configured here such that only reflected or remitted measurement light beams are imaged on the sensor and light beams from different wavelength ranges are deflected away from the light receiver, for example a beam trap. The reception optics then acts in a similar manner to an optical filter.

Alternatively or additionally, an optical filter can be arranged upstream of the light receiver for a suppression of interference light, in particular of reflected or remitted pilot light beams. The optical filter can likewise be configured as a metasurface.

The control and evaluation unit of the sensor can be adapted to provide different operating modes of the sensor. An operating mode can, for example, be an alignment or adjustment mode in which the nonlinear optical element is introduced into the transmission beam path so that the measurement light beam and the pilot light beam are activated simultaneously. A further operating mode can be a measurement mode in which the nonlinear optical element has been removed from the transmission beam path so that the pilot light beam is deactivated and interference light generated by the pilot light beam is reduced for the light receiver.

In accordance with a further development, the optoelectronic sensor is configured to determine the distance of the respective surface from the sensor from a time of flight of a pulsed light signal to the respective surface and back or from the phase shift of a modulated light signal transmitted by the sensor with respect to the light signal reflected at the respective surface. The optoelectronic sensor can therefore in particular work in accordance with the time of flight (TOF) principle.

The method in accordance with the invention can be further developed in a similar manner and shows similar advantages in so doing. Such advantageous features are described in an exemplary, but not exclusive manner in the subordinate claims dependent on the independent claims.

The invention will be explained in detail in the following with reference to an embodiment and to the drawing. There are shown in the drawing:

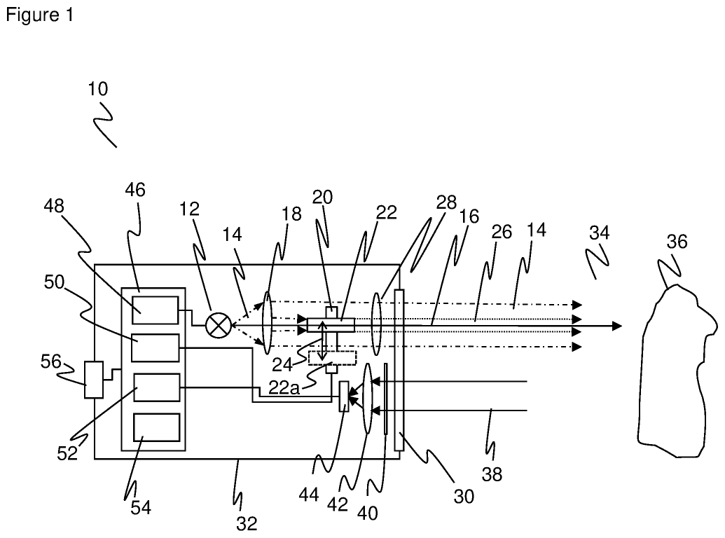

FIG. 1 a schematic representation of an optoelectronic sensor in accordance with the invention;

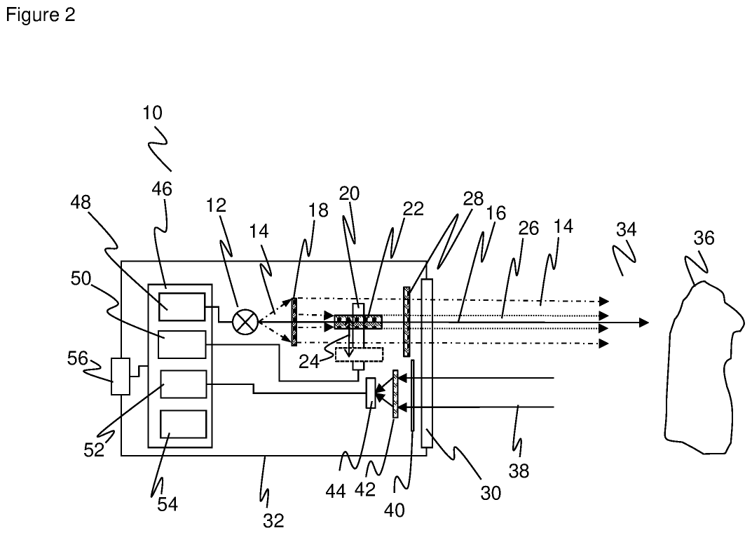

FIG. 2 a schematic representation of an optoelectronic sensor in accordance with the invention with components comprising optical metamaterials;

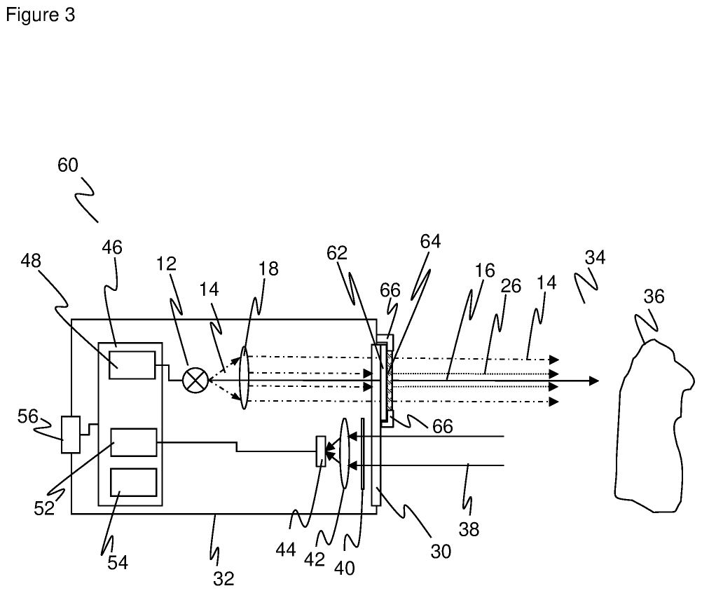

FIG. 3 a schematic representation of an embodiment of the invention with a film having a nonlinear optical element;

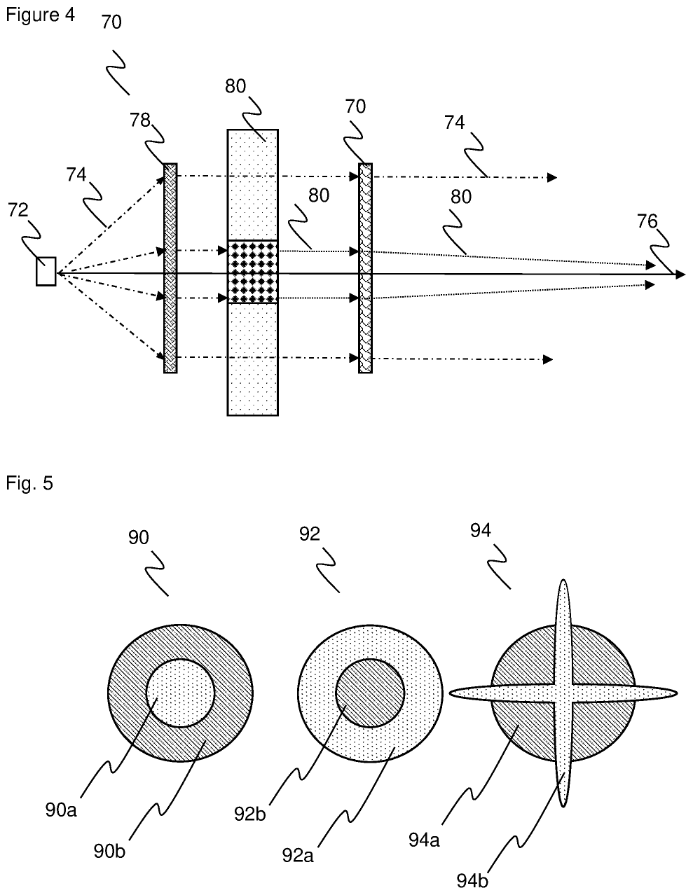

FIG. 4 an exemplary arrangement for the frequency multiplication and beam shaping in an optoelectronic sensor in accordance with the invention; and

FIG. 5 exemplary light spots generated by the measurement light beam and the pilot light beam on an incidence on an object in the monitored zone.

FIG. 1 shows a schematic representation of an optoelectronic sensor 10 in an embodiment as a light sensor. The sensor 10 has a measurement light source 12, for example a laser diode or a vertical cavity surface emitting laser (VCSEL) that emits a measurement light beam 14 (represented by chain dotted lines) in the infrared wavelength range along a transmission beam path 16. A collimation optics 18 for collimating the measurement light beam 14 is arranged downstream of the measurement light source 12 in the light beam direction. The collimation optics 18 is here first shown purely by way of example as a biconvex lens, but can have a more complex design, for example as an objective having a plurality of lenses.

A mechanism 20 is configured to move a nonlinear optical element 22 (as indicated by the double arrow 24) into and out of the transmission beam path 16 of the sensor 10. The moved out state of the nonlinear optical element is shown by a dashed rectangle 22a. A filter wheel or a translation stage can serve as a suitable mechanism, for example. In the moved in state, the nonlinear optical element 22, for example a birefringent crystal, converts a portion of the measurement light beam 14 in the infrared wavelength range into a pilot light beam 26 (represented by chain dotted lines) in the visible wavelength range.

The measurement light beam 14 and the pilot light beam 26 can be projected through a window 30 in the housing 32 of the sensor 10 into a monitored zone 34 by a transmission optics 28 arranged downstream of the nonlinear optical element 22 in the light beam direction. The transmission optics 28 can be configured to set the beam diameter and the aperture angle of the measurement light beam 14 and/or of the pilot light beam 26. The transmission optics 28 is, like the collimation optics 18 first shown purely by way of example as a biconvex lens, but can have a more complex design, for example as an objective having a plurality of lenses.

The light reflected or remitted at an object 36 in the monitored zone 34 is conducted as received light 38 onto a light receiver 44 via an (optional) optical filter 40 to suppress interference light and a reception optics 42.

The light receiver 44 is preferably formed as a photodiode, APD (avalanche photodiode), or SPAD (single photon avalanche diode), or SPAD matrix (SPAD array).

A control and evaluation unit 46 that is connected to the measurement light source 12, to the pilot light source 20, to the mechanism, and to the light receiver 44 is furthermore provided in the sensor 10. The control and evaluation unit 46 comprises a measurement light source control 48, a mechanism control 50, a time of flight measuring unit 52, and an object distance estimation unit 54, with them initially only being functional blocks that can also be implemented in the same hardware or in other functional units as in the measurement light sources 12, the mechanism control 50, or in the light receiver 44. The control and evaluation unit 46 can output measured data via an interface 56 or can conversely accept control and parameterization instructions. The control and evaluation unit 46 can also be arranged in the form of local evaluation structures on a chip of the light receiver 12 or can interact as a partial implementation with the functions of a central evaluation unit (not shown).

FIG. 2 shows a further embodiment of an optoelectronic sensor 10 in accordance with the invention. Unlike the embodiment of FIG. 1, the collimation optics 18, the transmission optics 28, and the reception optics 42 have optical metasurfaces or are formed as optical metasurfaces. The sensor 10 can thereby have a more compact design since the extent of the metasurfaces in the light beam direction is considerably smaller than the extent of classical optics. The nonlinear optical element 22 likewise has an optical metamaterial, whereby a more efficient frequency conversion is possible in comparison with birefringent crystals.

FIG. 3 shows a further embodiment of the invention. An optoelectronic sensor 60, like the sensors from the embodiments shown FIG. 1 and FIG. 2, first has a measurement light source 12 that emits a measurement light beam 14 (represented by chain dotted lines) in the infrared wavelength range along a transmission beam path 16. A collimation optics 18 for collimating the measurement light beam 14 is arranged downstream of the measurement light source 12 in the light beam direction. The measurement light beam 24 is projected into a monitored zone 34 through a window 30 in the housing 32 of the sensor 60. The light reflected or remitted at an object 36 in the monitored zone 34 is conducted as received light 38 onto a light receiver 44 via an (optional) optical filter 40 to suppress interference light and a reception optics 44.

A control and evaluation unit 46 that is connected to the light measurement light source 12, to the pilot light source 20, and to the light receiver 44 is likewise provided in the sensor 60. The control and evaluation unit 46 comprises a measurement light source control 48, a time of flight measuring unit 52, and an object distance estimation unit 54, with them initially only being functional blocks that can also be implemented in the same hardware or in other functional units as in the measurement light sources 12, or in the light receiver 44. The control and evaluation unit 46 can output measured data via an interface 56 or can conversely accept control and parameterization instructions. The control and evaluation unit 46 can also be arranged in the form of local evaluation structures on a chip of the light receiver 12 or can interact as a partial implementation with the functions of a central evaluation unit (not shown).

In accordance with the invention, a film 62 can be releasably fastened to the window 30 of the sensor and has at least one nonlinear optical element 64 that is formed as a metasurface and converts at least a portion of the measurement light beam 14 in the infrared wavelength range into a pilot light beam 26 (represented by a dotted line) in the visible wavelength range. The releasable fastening of the film 62 can takes place by adhesion to the window 30 or by fastening elements 66 at the housing 42 or window 30 of the sensor 60. Suitable fastening elements 66 can, for example, be rails or clamps.

In an alternative embodiment of the invention, not shown, the nonlinear optical element 64 formed as a metasurface can be applied directly to a window that is exchangeable with the window 30 of the sensor 60. To set up the sensor 60, the window having the metasurface is then inserted into the sensor so that at least a portion of the measurement light beam 14 in the infrared wavelength range is converted into a pilot light beam 26 (represented by dotted lines) in the visible wavelength range. Once the sensor 60 has been aligned, the window having the metasurface can again be replaced with the window 30 of the sensor 60 so that the sensor only emits the measurement light beam 14 in the infrared wavelength range.

FIG. 4 shows a detailed sketch of an exemplary arrangement 70 for the frequency multiplication and beam shaping in an optoelectronic sensor in accordance with the invention. A measurement light source 72, for example a laser diode or a vertical cavity surface emitting laser (VCSEL) emits a divergent measurement light beam 74 (represented by chain dotted lines) in the infrared wavelength range along a transmission beam path 76. A collimation optics 78 for collimating the measurement light beam 74 is arranged downstream of the measurement light source 72 in the light beam direction. The collimation optics 78 is configured as an optical metasurface. The collimated measurement light beam 74 is incident on a nonlinear optical element 80 that is formed as a metamaterial or as a metasurface and that converts a portion of the measurement light beam 74 in the infrared wavelength range into a pilot light beam 82 in the visible wavelength range. The nonlinear optical element 80 can have different zones 80a, 80b, with measurement light beams 74 that are incident on a first zone 80a being converted into pilot light beams, whereas measurement light beams 74 that are incident on a second zone 80b pass through the nonlinear optical element 80 substantially unchanged. The nonlinear optical element 80 can therefore have zones that do not exert any nonlinear effect on the measurement light beam radiated in. A transmission optics 82 that can be configured to influence the measurement light beam 74 and/or the pilot light beam 82 independently of the wavelength is arranged downstream of the nonlinear optical element 80 in the beam direction. In the embodiment, the transmission optics 82 is designed such that the measurement light beam 74 substantially remains collimated while the pilot light beam 82 is focused on a point at a defined distance from the transmission optics. The transmission optics 82 can, however, in particular also be designed such that the measurement light beam 74 and the pilot light beam 82 are projected into the monitored zone 34 in a substantially collimated form.

FIG. 5 shows exemplary light spots 90, 92, 94 of measurement light beams and pilot light beams on an incidence on an object in the monitored zone. In the first exemplary light spot 90, the measurement light beam spot 90a is arranged concentrically about the pilot light beam 90b; in the second exemplary light spot 92, the pilot light beam spot 92b is arranged concentrically about the measurement light beam spot 92a. The third exemplary light spot 94 shows a cruciform pilot light beam spot 94b that is arranged centrally above a circular measurement light beam spot 94a. It is understood that the representations are purely exemplary; the light beam spots generated in the monitored zone are in particular not sharply defined as a rule.

The shape of the light spots 90, 92, 94 can, for example, take place by a corresponding structuring of the nonlinear optical element, by diffractive elements for beam shaping known from the prior art, or by a further optical metasurface formed for a corresponding beam shaping which can be moved into the optical path of the optoelectronic sensor by the nonlinear optical element.

1. An optoelectronic sensor, the optoelectronic sensor comprising:
at least one measurement light source for transmitting at least one measurement light beam in the infrared wavelength range along a transmission beam path into a monitored zone;
a light receiver for receiving measurement light beams remitted or reflected from the monitored zone and for generating corresponding received signals;
a control and evaluation unit for controlling the light receiver and the measurement light source and for evaluating the received signals; and
at least one nonlinear optical element for generating at least one pilot light beam in the visible wavelength range from at least one portion of the measurement light beam.

2. The optoelectronic sensor in accordance with claim 1, wherein the nonlinear optical element has at least one birefringent crystal.

3. The optoelectronic sensor in accordance with claim 1, wherein the nonlinear optical element is configured as an optical metamaterial.

4. The optoelectronic sensor in accordance with claim 1, wherein the nonlinear optical element is formed as an optical metasurface.

5. The optoelectronic sensor in accordance with claim 1, wherein the nonlinear optical element is arranged in the transmission beam path such that the measurement light beam and the pilot light beam extend in a collinear manner.

6. The optoelectronic sensor in accordance with claim 5, wherein the nonlinear optical element is arranged such that the measurement light beam and the pilot light beam extend in a coaxial manner.

7. The optoelectronic sensor in accordance claim 1, wherein a transmission optics for setting at least one of the aperture angle, the beam diameter of the measurement light beam, and the pilot light beam is arranged downstream of the nonlinear optical element in the light beam direction.

8. The optoelectronic sensor in accordance with claim 1, wherein a collimation optics for collimating the measurement light beam is arranged upstream of the nonlinear optical element in the light beam direction.

9. The optoelectronic sensor in accordance with claim 7, wherein the transmission optics is formed as a flat optics with at least one metasurface.

10. The optoelectronic sensor in accordance with claim 8, wherein the collimation optics is formed as a flat optics with at least one metasurface.

11. The optoelectronic sensor in accordance with claim 7, wherein a collimation optics for collimating the measurement light beam is arranged upstream of the nonlinear optical element in the light beam direction, and wherein the transmission optics and the collimation optics are formed as a flat optics with at least one metasurface.

12. The optoelectronic sensor in accordance with claim 1, wherein the nonlinear optical element can be moved into and out of the transmission beam path.

13. The optoelectronic sensor in accordance with claim 4, wherein the nonlinear optical element is part of a window of the optoelectronic sensor.

14. The optoelectronic sensor in accordance with claim 4, wherein the nonlinear optical element has a film that can be applied to a window of the optoelectronic sensor.

15. An optoelectronic sensor in accordance with claim 14, wherein the optoelectronic sensor has fastening elements for fastening the film to the window of the optoelectronic sensor.

16. A method of aligning an optoelectronic sensor in the manner of a light sensor, the method comprising the steps of:
generating at least one measurement light beam in the infrared wavelength range by a measurement light source;
transmitting the measurement light beam along a transmission beam path into a monitored zone;
moving a nonlinear optical element into the transmission beam path, wherein the nonlinear optical element generates at least one pilot light beam in the visible wavelength range; and
aligning the optoelectronic sensor with the aid of light spots generated in the monitored zone by the pilot light beam.

17. The method in accordance with claim 16, wherein the nonlinear optical element is introduced into the transmission beam path by a mechanism in the sensor.

18. The method in accordance with claim 16, wherein the nonlinear optical element is formed as an optical metasurface on a film that is applied to a window of the sensor.
